(19) United States
(12) Patent Application Publication
(10) Pub. No.: US 2018/0187457 A1
(43) Pub. Date: Jul. 5, 2018

(54) VEHICLE DOOR LATCHING DEVICE

(71) Applicant: Mitsui Kinzoku Act Corporation, Yokohama-shi, Kanagawa (JP)

(72) Inventors: Tomoharu Nagaoka, Yokohama (JP); Hideaki Nozawa, Yokohama (JP)

(73) Assignee: Mitsui Kinzoku Act Corporation, Yokohama-shi, Kanagawa (JP)

(21) Appl. No.: 15/740,590

(22) PCT Filed: Jan. 28, 2016
(86) PCT No.: PCT/JP2016/052552

§ 371 Date: Dec. 28, 2017

(51) Int. Cl. E05B 79/04; E05B 85/02; E05B 81/04

(52) U.S. Cl. CPC E05B 79/04; E05B 81/04; E05B 85/02

(57) ABSTRACT

Provided is a vehicle door latching device that can be assembled in a door more easily. A hole to be engaged is provided in a portion of a housing that faces an inner panel to which a cover plate is fixed, wherein the hole to be engaged allows an engaging unit and an operating unit to be suspended in a door by way of engaging with an engaging part of the inner panel in a state in which the engaging unit is not anchored to the inner panel.

### TECHNICAL FIELD

The present invention relates to a vehicle door latch device capable of improving assembling workability into a door.

### BACKGROUND OF THE INVENTION

A general door latch device attached to a door of a vehicle comprises an engagement unit having a synthetic resin body that includes an engagement mechanism such as a latch capable of engaging with a striker on the vehicle body side and a ratchet (or pole) capable of engaging with the latch and having a metal cover plate that occludes an opening surface provided in the body, and a housing fixed to the engagement unit so as to form a substantially L shape in a plan view and including an operation mechanism that includes an actuator consisting of a motor capable of switching an unlocking state in which the engagement state of the engagement mechanism with the striker can be released and a locking state in which the engagement state cannot be released.

When such a door latch device is assembled inside the door, for example, as disclosed in Patent Literature 1, in a state that the door latch device is disposed in a space between an inner panel and an outer panel of the door, the engagement unit is fixed to an end surface of the inner panel by a plurality of bolts from the outside.

In addition, in the door latch device disclosed in Patent Literature 1 (a door locking device in Patent Literature 1), a vicinity of a connector portion to which an electrically conducting coupler in the housing is connected is also fixed to the inner panel of the door through a bracket by a single bolt from a vehicle interior side.

### PRIOR ART

### Patent Literature

Patent Literature 1: JP4136880B2

### SUMMARY OF THE INVENTION

### Problem to be Solved by the Invention

However, in order to assemble the door latch device to the door as described above, the door latch device is inserted into the door from an working hole provided in the inner panel, while holding the door latch device with one hand, the other hand holds a tool, then, while aligning screw holes provided in the cover plate and insertion holes of the bolts provided in the inner panel, the door latch device has to be fixed to the inner panel by a plurality of bolts. Therefore, assembling workability is poor, and assembling efficiency of the door latch device is lowered.

In view of the above problems, it is an object of the present invention to provide a vehicle door latch device that can improve assembling workability into the door.

### Means for Solving the Problems

The above object is solved by the present invention as follows.

A first invention is a vehicle door latch device, the device comprises an engagement unit having a body which includes an engagement mechanism capable of engaging with a striker of a vehicle body side and is intended to be fixed to an inner panel inside a door by a plurality of bolts, an operation unit coupled to the body at a substantially right angle so as to be faced to an inner surface of a vehicle interior side of the inner panel and having a housing including elements capable of switching an unlocking state that can release the engagement state between the engagement mechanism and the striker and a locking state that cannot release the engagement state, and an engaged portion capable of suspending the engagement unit and the operating unit inside the door,

wherein, in the engagement unit or the operation unit, the engaged portion is provided at least one of a facing portion facing the inner panel to which the body is fixed and a facing portion facing the inner surface of the vehicle interior side of the inner panel in the housing, such that the engagement unit and the operating unit can be suspended inside the door by engaging the engaged portion with the inner panel in a state that the engagement unit is not fixed to the inner panel.

A second invention is a vehicle door latch device in the first invention described above wherein the engaged portion provided in the engagement unit or the operating unit is an engaged hole capable of engaging with an upward hook-shaped engaging piece provided in the inner panel.

A third invention is a vehicle door latch device in the first invention described above wherein the engaged portion provided in the engagement unit or the operating unit is a downward hook-shaped engaged piece capable of engaging with an engaging hole provided in the inner panel.

A fourth invention is a vehicle door latch device in the second or third invention described above wherein the engaged hole or the engaged piece is provided in an upward projection formed so as to project upward on an upper surface close to a vehicle exterior side of the housing in the operation unit.

A fifth invention is a vehicle door latch device in any one of the first to fourth inventions wherein the engaged portion provided in the housing is an elastic engaging piece formed on an outer peripheral surface of a connector connecting portion which is provided in a side surface of a vehicle interior side of the housing in order to electrically conduct to the electrical elements, and the elastic engagement piece is engaged with a peripheral surface of a vehicle interior side of an opening portion provided in the inner panel by fitting the connector connecting portion into the opening portion together with the elastic engaging piece.

### Advantages of the Invention

According to the present invention, by engaging the engaged portion provided at least one of the engagement unit or the operation unit and the housing with the engaging portion of the inner panel, the door latch device can be temporarily held inside the door. Therefore, the bolt fixing operation can be performed in a state that a hand is released from the door latch device, and the assembling workability of the door latch device into the door can be improved.

### BRIEF DESCRIPTION OF THE DRAWINGS

FIG. 1 is a perspective view of a door latch device according to an embodiment of the present invention and a part of a door to which the door latch device is attached viewed from an obliquely rear of a vehicle interior side.

FIG. 2 is a rear view of the door latch device of FIG. 1 viewed from a rear of the vehicle.

FIG. 3 is a side view of the door latch device of FIG. 1 viewed from a vehicle interior side.

FIG. 4 is an enlarged vertical cross-sectional view taken along a line IV-IV in FIG. 2.

FIG. 5 is an enlarged vertical cross-sectional view taken along a line V-V in FIG. 2.

FIG. 6 is an enlarged vertical cross-sectional view taken along a line VI-VI in FIG. 3.

FIG. 7 is an enlarged vertical cross-sectional view of the same portion as FIG. 6 on the way of inserting a connector connecting portion into an opening portion of an inner panel.

FIG. 8 is an enlarged vertical cross-sectional view showing a modified example of an engaging portion and an engaged portion.

### EMBODIMENTS OF THE INVENTION

Hereinafter, one embodiment of the present invention will be described with reference to the drawings.

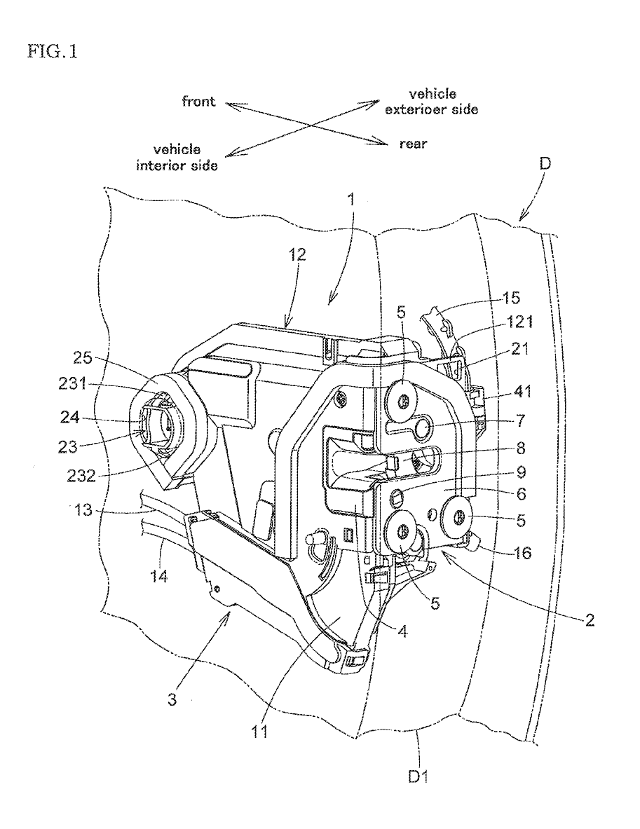

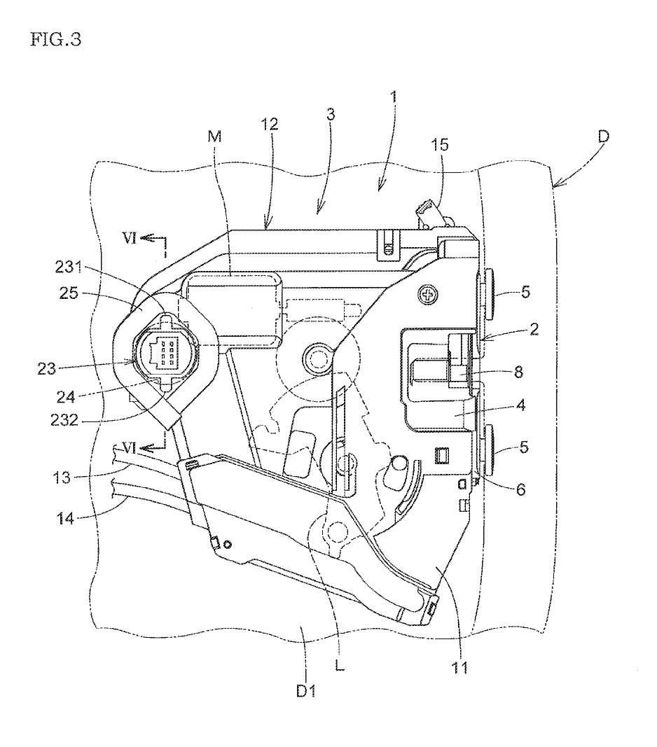

As shown in FIGS. 1 to 3, a door latch device 1 according to the present invention, for example, in a rear door (hereinafter simply referred to as a door) D on a right side of a vehicle, is fixed to a rear end surface of an inner panel D1 of the door D, and comprises an engagement unit 2 for holding the door D in a closed state, and an operation unit 3 fixed to the engagement unit 2.

The engagement unit 2 comprises a box-shaped synthetic resin body 4 having a rear surface opened, and a metal cover plate 6 fixed to the rear surface so as to cover an opening surface of the body 4 and fixed to a rear end surface of the inner panel D1 inside the door D together with the body 4 by three bolts 5. An internal space between the body 4 and the cover plate 6 includes an engagement mechanism containing a latch 8 pivotally mounted on a latch shaft 7 extending in a front-rear direction and having a striker entry groove 81 capable of engaging with a striker S on a vehicle body side, and a pole 10 supported on the pole shaft 9 extending in the front-rear direction and preventing rotation of the latch 8 to the opening direction (direction of releasing the engagement with the striker 5) by engaging with the latch 8. In addition, the cover plate 6 constitutes a part of the body 4.

The operation unit 3 is coupled to the body 4 at a substantially right angle in an L shape in a plan view so as to be faced to an inner surface of a vehicle interior side of the inner panel. The operation unit 3 comprises a synthetic resin housing 12 whose opening surface of a vehicle interior side is occluded by a synthetic resin cover 11, and an operating mechanism such as various operation levers and a locking/unlocking motor M that are incorporated in the housing 12 and are elements capable of switching an unlocking state that can release an engagement state between the engagement mechanism and the striker S and a locking state that cannot release the engagement state. The various operation levers comprise a locking/unlocking lever L connected through a first Bowden cable 13 to a lock knob (not shown) for manual operation provided in a vehicle interior side of the door D and moving to an unlocking position enabling an opening operation of the door D and a locking position disabling the opening operation, an inside lever (not shown) connected through a second Bowden cable 14 to an inside handle (not shown) provided in the vehicle interior side of the door D, a release lever (not shown) rotated to the unlocking position and the locking position in conjunction with the locking/unlocking lever L, wherein the release lever, when it is in the unlocking position, moves upward in conjunction with the inside handle and the releasing operation of an outside lever 16 described later and enables the opening of the door D by rotating the pole 10 in a direction to detach from the latch 8, and a child lever (not shown) capable of switching a child unlocking state that the releasing operation of the inside lever can be transmitted to the pole 10 through the release lever and a child locking state that the releasing operation of the inside lever cannot be transmitted. The cover 11 occluding the opening surface of the housing 12 constitutes a part of the housing 12.

Since the various levers and the locking/unlocking motor M and the like constituting the operating mechanism are well-known ones that are mounted on an usual door latch device, their detailed descriptions will be omitted.

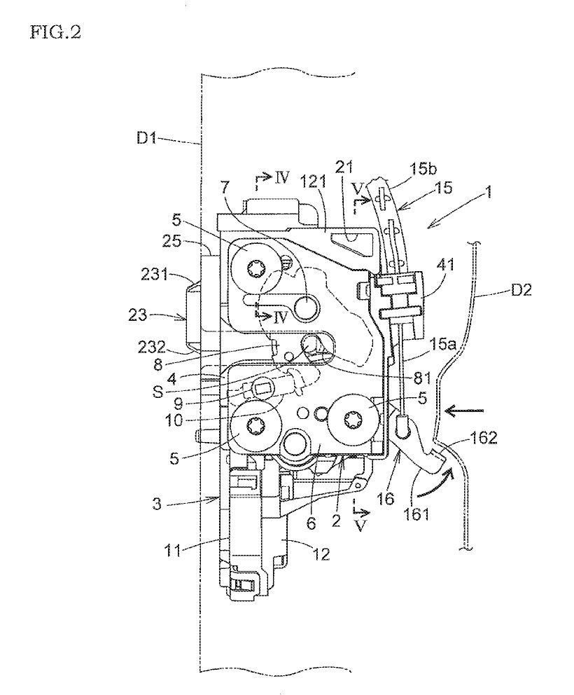

In a back surface side (front surface side) of the body 4, an outside lever 16 connected through an inner cable 15a of a third Bowden cable 15 to an outside handle (not shown) provided in a vehicle exterior side of the door and rotating counterclockwise viewed from the rear of FIG. 2 by an opening operation of the outside handle, and a sub-outside lever (not shown) linked to the outside lever 16 and rotating clockwise viewed from the rear in conjunction with the rotating of the outside lever 16 are pivotally mounted by shafts (not shown) extending in a front-rear direction respectively. An end portion of a vehicle interior side of the sub-outside lever is linked to the release lever described above, if the outside handle is operated to open when the locking/unlocking lever is in the unlocking position, the pawl 10 rotates in a direction away from the latch 8 and the door D can be opened.

As shown in FIG. 2, a lower end portion of an outer casing 15b in the third Bowden cable 15 is fitted and held so as not to be able to move in a vertical direction inside a cable holding portion 41 that is formed in an upper portion of a side surface of a vehicle exterior side of the body 4 and is a U-shaped in a plan view with a rear surface opened in an upper part of the outside lever 16. The lower end portion of the inner cable 15a of the third Bowden cable 15 is connected to the projecting portion of the outside lever 16 at a position close to a side surface of a vehicle exterior side of the engagement unit 2, when the outside handle is operated to open, the outside lever 16 is pulled upward, so that the door can be opened.

On the outside lever 16, an extending portion 161 extending to a vehicle exterior direction from a connecting portion of the inner cable 15a is formed. A side portion of a vehicle exterior side of the outside lever 16 including the extending portion 161 is inclined obliquely downward in a stand by state that the outside handle is not operated to open. A forward bent portion 162 facing the front is formed at a tip portion of the extending portion 161. As described above, when the side portion of the vehicle exterior side of the outside lever 16 including the extending portion 161 is inclined obliquely downward and the forward bent portion 162 is formed at a tip portion of the side portion, as shown by the two-dot chain line in FIG. 2, for example, when the outer panel D2 of the door D is deformed in a vehicle interior direction due to a crash of the vehicle and the deformed portion enters into a rotational locus of an end portion of the vehicle exterior side of the outside lever 16, the forward bent portion 162 is positioned below the deformed portion of the outer panel D2. Therefore, even if the outside lever 16 is rotated to the door opening direction (counterclockwise direction) due to inertia at the time of crash, the forward bent portion 162 abuts against a lower surface of the deformed portion of the outer panel D2, so that the door D is prevented from unexpected opening.

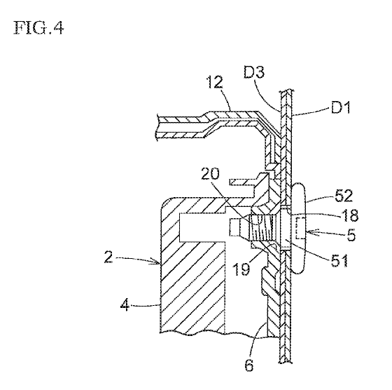

As shown in FIG. 4, a rear end portion of the inner panel D1 to which the cover plate 6 is fixed is reinforced by fixing a plate-shaped reinforcement D 3 on the inner surface (front surface) thereof. Three insertion holes 18 to which the shaft portions of the three bolts 5 described above are inserted are drilled in a portion that the cover plate 6 is fixed in the inner panel D1 including the reinforcement D3. The diameter of the insertion hole 18 is slightly larger than the diameter of a base shaft portion 51 of the bolt 5. The insertion hole 18 is a circular hole having no tapered portion projecting toward the cover plate 6 side, and there is also no tapered portion on a front side of a head portion 52 of the bolt 5, and the head portion 52 is a disk shape having a relatively small thickness.

In a state that the door latch device 1 is inserted into the door, the bolt 5 inserted into each insertion hole 18 of the inner panel D1 is screwed into and tightened a female screw hole 20 continuous with a tapered hole portion 19 formed in the cover plate 6, so that the entire door latch device 1 is fixed to the rear end portion of the inner panel D1. In addition, the diameter of the head portion 52 of the bolt 5 is larger than the diameter of a head portion of the bolt for fixing the general door latch device, and the contact area between the inner panel D1 and the head portion 52 is made large, so that a coupling strength of the cover plate 6 to the inner panel D1 can be enhanced.

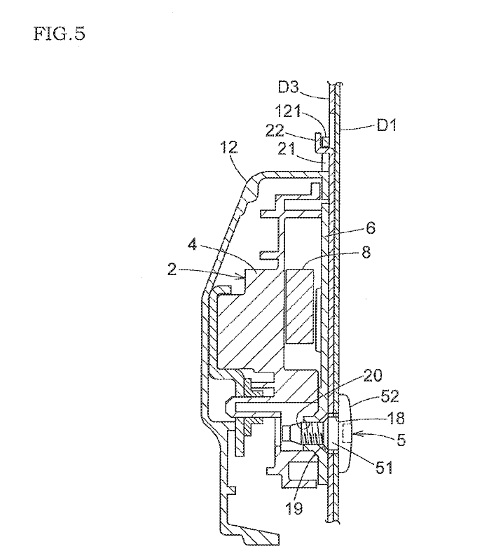

As shown in FIGS. 2 and 5, an upward projection 121 is integrally formed on the upper part of the cover plate 6 and the upper surface close to the vehicle exterior side of the housing 12. In the upward projection 121, an engaged hole 21 capable of engaging with an engaging piece 22 described later of the reinforcement D3 and opening in the same direction (front-rear direction) as the insertion hole 18 described above is provided.

On the other hand, on the reinforcement D3 in the inner panel D1, an engaging piece 22 bent in an upward hook shape toward the front upper side with which the engaged hole 21 can engage is provided. The engaging piece 22 can be integrally formed by cutting and raising a part of the reinforcement D3. When the engaged hole 21 is engaged with the engaging piece 22, the engaged hole 21 and the engaging piece 22 are provided at positions capable of positioning by aligning the three female screw holes 20 of the cover plate 6 with the three insertion holes 18 of the inner panel D1. In a state that the engaged hole 21 is engaged with the engaging piece 22, in order to slightly move the door latch device 1 in the vehicle interior and exterior directions, a width dimension of the engaging piece 22 in the vehicle interior and exterior directions is set to be smaller than an opening width of the engaged hole 21 in the vehicle interior and exterior direction.

As shown in FIG. 5, when the engaged hole 21 of the housing 12 is engaged with the engaging piece 22 of the reinforcement D3 in the inside of the door, the rear surface of the cover plate 6 abuts against the front surface of the reinforcement D3, and in a state that the three female screw holes 20 of the cover plate 6 and the three insertion holes 18 of the inner panel D1 are aligned, the engagement unit 2 and the operation unit 3 can be temporarily held in a state that they are suspended inside the door D.

As shown in FIGS. 1, 3 and 6, at a side surface of a vehicle interior side of the cover 11 of the housing 12, that is, at a front end portion of a facing portion facing an inner surface of a vehicle interior side of the inner panel D1, a substantially cylindrical connector connecting portion 23 having a flat upper surface and a flat lower surface is integrally projected so as to face the vehicle interior direction. A male connector (not shown) of a wire harness for electrically conducting to electric elements such as a locking/unlocking motor M in the housing 12 is connected to the connector connecting portion 23.

An upper elastic engaging piece 231 inclined obliquely upward from a distal end of a vehicle interior side of the connector connecting portion 23 toward the vehicle exterior direction on the flat upper surface of the connector connecting portion 23 and a lower elastic engaging piece 232 inclined obliquely downward from a distal end of the vehicle inner side of the connector connecting portion 23 toward the vehicle exterior direction on the flat lower surface of the connector connecting portion 23 are integrally formed respectively. Front-rear dimensions of the upper elastic engaging piece 231 and the lower elastic engaging piece 232 are smaller than front-rear widths of the upper and lower flat surfaces of the connector connecting portion 23 and the lengths thereof are about half of a projecting dimension of the connector connecting portion 23. The upper elastic engaging piece 231 can be elastically deformed downward, and the lower elastic engaging piece 232 can be elastically deformed upward.

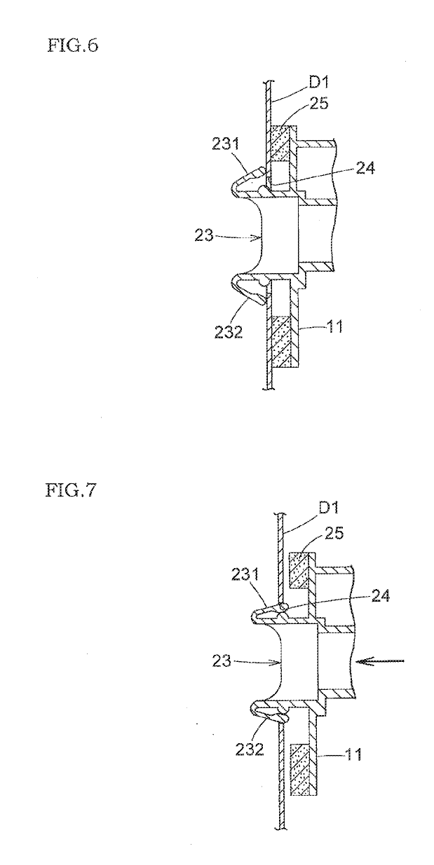

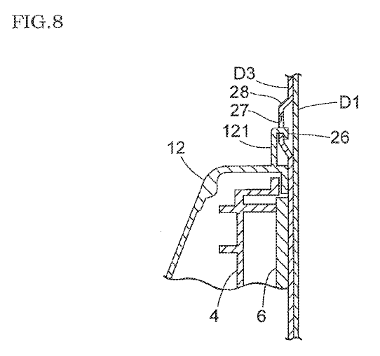

In the inner panel D1 of a vehicle interior side, a circular opening portion 24 into which the connector connecting portion 23 is fitted is formed. As shown in FIG. 7, in a state that an elastic sealing material 25 is adhered to a side surface of a vehicle interior side of the cover 11 so as to surround the connector connecting portion 23, when the upper elastic engaging piece 231 and the lower elastic engaging piece 232 are fitted to the opening portion 24 together with the connector connecting portion 23 from the vehicle exterior side, the upper elastic engaging piece 231 and the lower elastic engaging piece 232 are elastically deformed downward and upward respectively.

As shown in FIG. 6, when the upper elastic engaging piece 231 and the lower elastic engaging piece 232 are further pushed until they pass through the opening portion 24, the upper elastic engaging piece 231 elastically restores upward and the lower elastic engaging piece 232 elastically restores downward. The end surfaces of the vehicle exterior side of the elastic engaging pieces 231 and 232 are engaged with a peripheral surface of a vehicle interior side of the opening portion 24, so that the connector connecting portion 23 is prevented falling off from the opening portion 24, and the operation unit 3 is prevented from moving downward and is held in the door D. When the connector connecting portion 23 is pushed in, the elastic sealing material 25 is slightly compressed, so that the connector connecting portion 23 is prevented from moving in the vehicle interior and exterior direction and a sealing property around the connector connecting portion 23 is maintained.

In assembling the door latch device 1 of the above described embodiment into the door D, first, the door latch device 1 is inserted into the door D from the working hole provided in the inner panel D1 of the vehicle interior side, and the engaged hole 21 provided in the housing 12 of the door latch device 1 is engaged with the engaging piece 22 provided in the reinforcement D3 of the inner panel D1. Then, the connector connecting portion 23 provided in the cover 11, and the upper elastic engaging piece 231 and the lower elastic engaging piece 232 formed integrally with it are fitted into the opening portion 24 provided in the inner panel D1 of the vehicle interior side from the vehicle exterior side.

As described above, in a state that the three female screw holes 20 of the cover plate 6 and the three insertion holes 18 of the inner panel D1 are aligned, the engagement unit 2 can be suspended and temporarily held in the door D, further, the upper elastic engaging piece 231 and the lower elastic engaging piece 232 in the connector connecting portion 23 of the cover 11 are engaged with the peripheral surface of the vehicle interior side of the opening portion 24 and are prevented from falling off, so that the front end portion of the operation unit 3 is suspended and held by the inner panel D1. Therefore, it is not necessary to hold the door latch device 1 with one hand inside the door as in the past, and the tightening operation of the bolt 5 can be easily performed in a state that a hand is released from the door latch device 1, so that the assembling workability and assembling efficiency of the door latch device 1 into the door can be greatly improved.

Since the upper elastic engaging piece 231 and the lower elastic engaging piece 232 are provided on the upper and lower surfaces of the connector connecting portion 23, even if the entire door latch device 1 is drawn slightly to the inner panel D1 side when the cover plate 6 is fixed to the inner panel D1 with the bolts 5, there is no possibility that the both elastic engaging pieces 231 and 232 fall into the opening portion 24 and the connector coupling portion 23 is disengaged from the opening portion 24. On the other hand, for example, in the case that the both elastic engaging pieces 231 and 232 are provided on the front and rear surfaces of the connector connecting portion 23, when the entire door latch device 1 is drawn backward, there is a possibility that the elastic engaging piece of the front side falls into the opening portion 24 and the connector coupling portion 23 is detached from the opening portion 24.

FIG. 8 shows a modified example of an engaging portion and an engaged portion according to the present invention. Contrary to the above embodiment, a downward hook-shaped engaged piece 26 facing the rear is provided on an upper end portion of the upward projection 121 formed on the upper surface slightly forward than the cover plate 6 in the housing 12, and an engaging hole 27 to which the engaged piece 26 is engaged is provided in the reinforcement D3 side. In this case, for example, a part of the reinforcement D3 may be bulged forward so as to be separated from the inner panel D1, and the engaging hole 27 may be provided in a bulging portion 28. Also in this modified example, by engaging the engaged piece 26 with the engaging hole 27, the door latch device 1 can be suspended and temporarily held inside the door in a state that the hand is released from the door latch device.

Although the embodiments of the present invention have been described above, the following various variations and modifications can be made to the present embodiments within the scope not deviating from the gist of the present invention.

In the above embodiments, although the upward projection 121 is formed on the synthetic resin housing 12 in the operation unit 3 and the engaged hole 21 or the engaged piece 26 is provided in the upward projection 121, for example, the shape of the body 4 or the cover plate 6 constituting the engagement unit 2 may be appropriately changed so as to project upward a part of the vehicle exterior side of them, and the engaged hole 21 or the engaged piece 26 may be provided in any one of them.

Further, the engaged portion provided in the housing 12 may be a recessed portion recessed forward in place of the engaged hole 21, and an engaging portion such as a projecting piece engaged with the recessed portion may be provided in the reinforcement D3 side. Also in the modified example of FIG. 8, the engaging hole 27 of the reinforcement D3 side may be a recessed portion recessed backward, and an engaged portion such as a projecting piece engaged with the recessed portion may be provided in the housing 12 side. In short, the engaging portion and the engaged portion are not limited to the shapes of the embodiments as long as the engagement unit 2 and the operating unit 3 can be suspended and temporarily held inside the door.

Furthermore, in the above embodiment, the upper elastic engaging piece 231 and the lower elastic engaging piece 232 as the engaged portions are provided in the connector connecting portion 23 provided in the cover 11, and these are engaged with the peripheral surface of the vehicle interior side of the opening portion 24 of the inner panel D1. However, when the connector connecting portion 23 projecting in the vehicle interior direction is not provided, an engaging hole as an engaged portion or a downward hook-shaped engaging piece facing the vehicle interior direction is provided at the side surface of the vehicle interior side of the cover 11 constituting a part of the housing 12, and they may be engaged with an upward hook-shaped engaging piece or an engaging hole as an engaging portion provided in the inner surface of the vehicle interior side of the inner panel D1.

The engaged hole 21 or the engaged piece 26 is provided only in the upward projection 121 of the housing 12 and the upper elastic engaging piece 231 and the lower elastic engaging piece 232 as the engaged portion provided in the connector connecting portion 23 may be omitted. On the contrary, when the engaged portion that engages with the engagement provided in the inner panel D1 and can suspend the door latch device 1 is provided in the facing portion of the vehicle interior side of the inner panel D1 in the housing 12, the engaged hole 21 or the engaged piece 26 provided in the upward projection 121 of the housing 12 may be omitted.

When the inner panel D1 does not have the reinforcement D3, a metal piece provided with the engaging piece 22 or the engaging hole 27 may be fixed to the front surface of the inner panel D1.

In the above embodiment, although the door latch device attached to the rear door of the vehicle has been described, it goes without saying that the present invention can also be applied to a door latch device attached to the front door.

### REFERENCE SIGNS LIST

1 door latch device
2 engagement unit
3 operating unit
4 body
5 bolt
6 cover plate
7 latch shaft
8 latch
9 pole shaft
10 pole
11 cover
12 housing
13 first Bowden cable
14 second Bowden cable
15 third Bowden cable
15a inner cable
15b outer casing
16 outside lever
18 insertion hole
19 tapered hole portion
20 female screw hole
21 engaged hole (engaged portion)
22 engaging piece (engaging portion)
23 connector connecting portion
24 opening portion
25 elastic sealing material
26 engaged piece (engaged portion)
27 engaging hole (engaging portion)
28 bulging portion
41 cable holding portion
51 base shaft portion
52 head portion
81 striker entry groove
121 upward projection
161 extending portion
162 forward bent portion
231 upper elastic engaging piece (engaged portion)
232 lower elastic engaging piece (engaged portion)
D door
D1 inner panel
D2 outer panel
D3 reinforcement
L locking/unlocking lever
M motor
S striker

What is claimed is:

1. A vehicle door latch device comprising:
an engagement unit having a body which includes an engagement mechanism capable of engaging with a striker of a vehicle body side and is intended to be fixed to an inner panel inside a door,
an operation unit coupled to the body at a substantially right angle so as to be faced to an inner surface of a vehicle interior side of the inner panel, and having a housing including elements capable of switching an unlocking state that can release the engagement state between the engagement mechanism and the striker and a locking state that cannot release the engagement state, and
an engaged portion capable of suspending the engagement unit and the operating unit inside the door,
wherein, in the engagement unit or the operation unit, the engaged portion is provided at least one of a facing portion facing the inner panel to which the body is fixed and a facing portion facing the inner surface of the vehicle interior side of the inner panel in the housing, such that the engagement unit and the operating unit can be suspended inside the door by engaging the engaged portion with the inner panel in a state that the engagement unit is not fixed to the inner panel,
the engaged portion provided in the housing is an elastic engaging piece formed on an outer peripheral surface of a connector connecting portion which is provided in a side surface of a vehicle interior side of the housing in order to electrically conduct to the electrical elements, and the elastic engagement piece is engaged with a peripheral surface of a vehicle interior side of an opening portion provided in the inner panel by fitting the connector connecting portion into the opening portion together with the elastic engaging piece.

2. The vehicle door latch device of claim 1, wherein the engaged portion provided in the engagement unit or the operating unit is an engaged hole capable of engaging with an upward hook-shaped engaging piece provided in the inner panel.

3. The vehicle door latch device of claim 1, wherein the engaged portion provided in the engagement unit or the operating unit is a downward hook-shaped engaged piece capable of engaging with an engaging hole provided in the inner panel.

4. The vehicle door latch device of claim 2 or 3, wherein the engaged hole or the engaged piece is provided in an upward projection formed so as to project upward on an upper surface close to a vehicle exterior side of the housing in the operation unit.

5. (canceled)
